(19) United States
(12) Patent Application Publication
(10) Pub. No.: US 2026/0146182 A1
(43) Pub. Date: May 28, 2026

(54) ABRASIVE TAPE, AND MAGNETIC RECORDING MEDIUM PRODUCTION METHOD

(71) Applicant: Resonac Hard Disk Corporation, Chiba (JP)

(72) Inventors: Ayumi YAMAKAWA, Chiba (JP); Koshiro YOSHIYAMA, Chiba (JP); Shota SHIMADA, Tokyo (JP); Kazuhiro MAKISHIMA, Tokyo (JP); Kazunori OHASHI, Tokyo (JP)

(21) Appl. No.: 19/355,451

(22) Filed: Oct. 10, 2025

(30) Foreign Application Priority Data
Oct. 15, 2024 (JP) 2024-179688

(51) Int. Cl. C09J 7/29; B24D 11/02

(52) U.S. Cl. CPC C09J 7/29; B24D 11/02; C09J 2301/122; C09J 2301/16; C09J 2433/003; C09J 2467/006

(57) ABSTRACT

An abrasive tape that is an elongated tape wound in a roll shape includes a support; abrasive grains fixed, as an abrasive, to one surface of the support; and an adhesive layer over another surface of the support.

### CROSS-REFERENCE TO RELATED APPLICATIONS

The present application is based on and claims priority to Japanese Patent Application No. 2024-179688 filed on Oct. 15, 2024, the entire contents of which are hereby incorporated by reference.

### BACKGROUND

### 1. Field of the Invention

The present disclosure relates to an abrasive tape, and a magnetic recording medium production method.

### 2. Description of the Related Art

In recent years, magnetic storage devices are provided in various products, such as personal computers, video recorders, data servers, and the like, and the importance of the magnetic storage devices is increasing. The magnetic storage device includes a magnetic recording medium configured to store electronic data recorded through magnetic recording, and is, for example, a hard disk drive (HDD) device.

A typical magnetic recording medium has a multilayer film. This multilayer film is formed, for example, by sequentially forming a base layer, an intermediate layer, a magnetic recording layer, and a protective layer over a non-magnetic substrate, and applying a lubricating layer to a surface of the protective layer.

In the production of such a magnetic recording medium, a burnishing step is performed for removing foreign matter, projections, and the like, from the surface of the protective layer.

For example, Japanese Examined Patent Publication No. 1990-10486 discloses a surface smoothing method of a magnetic disk substrate. This disclosed surface smoothing method includes performing tape polishing on a lubricating protective film, formed on a surface of the magnetic disk substrate, using a wrapping film that is processed into a tape form, thereby abrading the lubricating protective film.

Also, for preventing foreign matter from adhering to an abrasive tape, for example, Japanese Unexamined Patent Publication No. 2008-264914 discloses an abrasive tape in which an abrasive layer formed on the surface of a plastic film is covered by a releasable protective film.

### SUMMARY

The present disclosure provides the following.
[1] An abrasive tape that is an elongated tape wound in a roll shape, the abrasive tape including:
a support,
abrasive grains fixed, as an abrasive, to one surface of the support, and
an adhesive layer over another surface of the support.
[2] The abrasive tape according to [1], wherein
the adhesive layer contains one or more adhesives selected from the group consisting of rubber-based adhesives, acrylic adhesives, urethane-based adhesives, and silicone-based adhesives.
[3] The abrasive tape according to [1] or [2], wherein
the support contains one or more resins selected from the group consisting of polyester-based resins, polyolefin-based resins, acrylic resins, and polycarbonates.
[4] The abrasive tape according to any one of [1] to [3], further including:
an undercoat layer between the support and the adhesive layer.
[5] The abrasive tape according to [4], wherein
the undercoat layer contains one or more adhesives selected from the group consisting of rubber-based resins, epoxy resins, polyurethane resins, acrylic resins, polyester resins, silicone resins, silane coupling agents, polyolefin-based resins, polycarbonate resins, and polyurethane resins.
[6] A magnetic recording medium production method, including:
burnishing, with an abrasive, a surface of a stack including a substrate, a magnetic recording layer over the substrate, and a protective layer over the magnetic recording layer, wherein
the burnishing includes
   by use of an abrasive tape that is elongated and is in a state of being wound in a roll shape, pressing the abrasive tape, supplied from the abrasive tape in the state of being wound in the roll shape, against the surface of the stack to abrade the surface of the stack, and
the abrasive tape includes
   a support,
   abrasive grains fixed, as the abrasive, to one surface of the support, and
   an adhesive layer over another surface of the support.
[7] The magnetic recording medium production method according to [6], further including:
forming a lubricating layer over the surface of the stack, wherein
the burnishing burnishes, with the abrasive, a surface of the stack over which the lubricating layer is formed.

### BRIEF DESCRIPTION OF THE DRAWINGS

FIG. 1 is a perspective diagram illustrating an example of an abrasive tape wound in a roll shape.

FIG. 2 is a cross-sectional diagram illustrating an example of a magnetic recording medium to be abraded with an abrasive tape according to an embodiment of the present disclosure.

FIG. 3 is a diagram for describing a burnishing step.

FIG. 4 is an enlarged cross-sectional diagram illustrating an example of the abrasive tape used in burnishing.

FIG. 5 is a diagram illustrating an example of a burnishing apparatus used in burnishing a stack with the abrasive tape.

### DETAILED DESCRIPTION OF THE DISCLOSURE

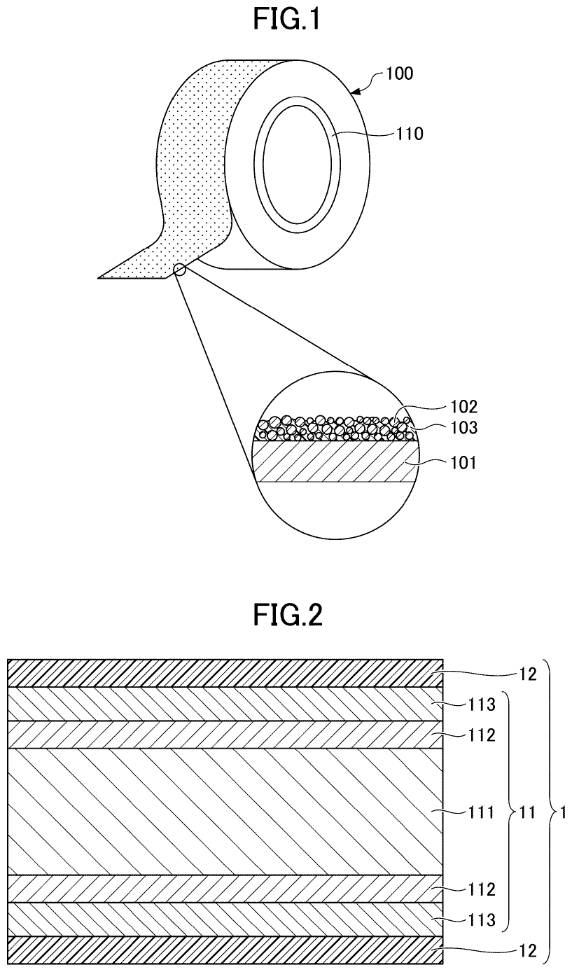

In a burnishing step, as illustrated in FIG. 1, an abrasive tape 100 is used in which abrasive grains 102, such as alumina or the like, are fixed to a resin film 101 with a resin 103. The abrasive tape 100 is an elongated tape having a width of several centimeters (cm) and a length of about 100 meters (m), and is supplied in a state of being wound around a core material 110 in a roll shape.

When foreign matter, released abrasive grains, or the like are mixed into the abrasive tape 100, circumferential scratches are formed in the surface of a multilayer film in the burnishing step, and stains are readily attached to the surface of the multilayer film. Therefore, the abrasive tape 100 is produced under quality control in which foreign matter, released abrasive grains, or the like are not mixed in the production process. However, in the production of the magnetic recording medium, there is still an instance that scratches, stains, or the like, possibly caused by the burnishing step, are formed. The magnetic recording medium having scratches, stains, or the like formed in the surface of the multilayer film is treated as a defective product, which lowers production efficiency of the magnetic recording media.

In one aspect, the present disclosure provides an abrasive tape that is capable of increasing production efficiency of magnetic recording media.

The inventors of the present disclosure focused on the fact that there is a correlation between: an occurrence rate of defective products caused by circumferential scratches, stains, and the like in the surfaces of the magnetic recording media; and positions in a roll of the abrasive tape used in the burnishing step. Then, they found that the occurrence rate of defective products caused by the burnishing step was higher when the burnishing step was performed by an outer portion, farther from the core material, of the roll of the abrasive tape than when the burnishing step was performed by an inner portion, closer to the core material, of the roll of the abrasive tape. According to the studies conducted by the inventors of the present disclosure, a reason for this was that a pressure due to tight winding of an abrasive tape in a roll shape generated released abrasive grains, and the released abrasive grains caused defective products. Since the pressure due to the tight winding is different between an inner side and an outer side of the roll, a difference in the amount of the released abrasive grains occurred between the inner side and the outer side of the roll. Therefore, the inventors of the present disclosure have found that, by providing an adhesive layer over a rear surface of the abrasive tape, i.e., a surface of a support forming the abrasive tape to which no abrasive grains are bonded, it is possible to mitigate the tight winding of the abrasive tape in a roll shape, and the adhesive layer can trap the abrasive grains released by the pressure due to the tight winding, thereby increasing the production efficiency of the magnetic recording media.

Hereinafter, embodiments of the present disclosure will be described in detail with reference to the drawings. For facilitating understanding of the description, the same components in the drawings are indicated by the same symbols, and duplicate description thereof is appropriately omitted. Also, dimensional proportions of the components in the drawings are not necessarily the same as in reality. In the present specification, a numerical range indicated by “A to B” refers to a numerical range including a lower limit “A” and an upper limit “B”, unless otherwise specified. In the numerical range indicated by “A to B”, when only the upper limit A is indicated in units, the lower limit B is indicated in the same units.

In the following, prior to describing an abrasive tape according to an embodiment of the present disclosure (hereinafter may be referred to simply as the present embodiment), a magnetic recording medium to be abraded with the abrasive tape according to the present embodiment will be described.

### Magnetic Recording Medium

FIG. 2 is a cross-sectional diagram illustrating an example of a magnetic recording medium to be abraded with the abrasive tape according to the embodiment of the present disclosure. As illustrated in FIG. 2, a magnetic recording medium 1 includes a stack 11 and lubricating layers 12 respectively formed over both surfaces of the stack 11.

The stack 11 includes a substrate 111, magnetic recording layers 112 respectively formed over both surfaces of the substrate 111, and protective layers 113 respectively formed over the magnetic recording layers 112.

The substrate 111 is formed of a non-magnetic material. The substrate 111 for use may be, for example, a metal substrate formed of a metal material, such as an aluminum alloy or the like. Alternatively, the substrate 111 for use may be, for example, a non-metal substrate formed of a non-metal material, such as glass or the like. In addition, an NiP alloy layer may be formed over the surface of the metal substrate and the non-metal substrate, for example, through plating or sputtering.

The magnetic recording layer 112 is provided for recording and reproducing information. For example, the magnetic recording layer 112 is provided for storing data by reversing the direction of magnetization by magnetic energy supplied from a magnetic head of an HDD, and maintaining the state of the resulting magnetization.

The magnetic recording layer 112 can be formed of an FePt-based alloy having an L1₀ structure, a CoPt-based alloy having an L1₀ structure, a CoCrPt-based alloy having an hcp structure, or the like.

The magnetic recording layer 112 can be formed using a typical film-forming, such as sputtering, ion beam deposition, or the like.

The protective layer 113 is provided for suppressing corrosion of the magnetic recording layer 112, and for protecting the surface of the magnetic recording medium 1 by suppressing damage to the surface of the magnetic recording medium 1 when the magnetic head contacts the magnetic recording medium 1, and enhancing corrosion resistance of the magnetic recording medium 1.

The protective layer 113 can be formed of a material typically used for a protective layer of a magnetic recording medium, such as a hard carbon film formed of diamond-like carbon (DLC) or the like.

The protective layer 113 can be formed using a typical film-forming method, such as sputtering, ion beam deposition, or the like.

The surface of the protective layer 113 may be hydrogenated (allowed to contain hydrogen atoms) or nitrogenated (allowed to contain nitrogen atoms). By hydrogenating or nitrogenating the surface of the protective layer 113, it is possible to increase a binding force of the protective layer 113 to the lubricating layer 12 to be formed over the surface of the protective layer 113.

The lubricating layer 12 is provided for suppressing abrasion of the magnetic head and the surface of the magnetic recording medium 1 when the magnetic head contacts the magnetic recording medium 1, and for enhancing corrosion resistance of the magnetic recording medium 1.

The lubricating layer 12 is formed using a lubricant. The lubricant may be a lubricant typically used for the production of a magnetic recording medium.

The thickness of the lubricating layer 12 is preferably 5 angstroms (Å) to 10 angstroms (Å). When the thickness of the lubricating layer 12 is 5 Å to 10 Å, it is possible to suppress abrasion of the surface of the magnetic recording medium 1 to enhance corrosion resistance of the magnetic recording medium 1, and reduce the distance between the magnetic head and the magnetic recording medium 1 in the HDD to realize a high recording density.

### Magnetic Recording Medium Production Method

A magnetic recording medium production method according to the present embodiment includes: forming the stack 11 including the magnetic recording layers 112 respectively formed over both main surfaces of the substrate 111, and the protective layers 113 respectively formed over the magnetic recording layers 112 (stack formation step); applying a lubricant to a surface of the stack 11 (application step); and burnishing, with an abrasive, a surface of the stack 11 to which the lubricant is applied (burnishing step).

In the magnetic recording medium production method according to the present embodiment, the burnishing step may be performed before the application step, i.e., the surface of the stack 11 to which no lubricant is applied may be burnished with the abrasive.

Also, the magnetic recording medium production method according to the present embodiment may include other steps, such as, for example, forming an adhesion layer, a soft magnetic base layer, a seed layer, or an orientation control layer between the substrate 111 and the magnetic recording layer 112.

Further, when the stack 11 includes a plurality of the magnetic recording layers 112 that are stacked, the stack formation step included in the magnetic recording medium production method according to the present embodiment may include, for example, forming a non-magnetic layer between the magnetic recording layers 112.

According to the magnetic recording medium production method according to the present embodiment, first, the stack 11 including: the magnetic recording layers 112 respectively formed over both main surfaces of the substrate 111 that was provided; and the protective layers 113 respectively formed over the magnetic recording layers 112 is formed (stack formation step).

The stack 11 can be formed using a typical film-forming method for the magnetic recording layers 112 and the protective layers 113.

First, the magnetic recording layers 112 are respectively formed over both main surfaces of the substrate 111. The formation of the magnetic recording layers 112 can be performed using a typical film-forming method, such as sputtering or the like.

For the sputtering, a target containing a material forming the magnetic recording layers 112 can be used.

As the target containing the material forming the magnetic recording layers 112, it is possible to use an FePt-based alloy, a CoPt-based alloy, a CoCrPt-based alloy, or the like.

As the sputtering, it is possible to use DC sputtering, DC magnetron sputtering, radio frequency (RF) sputtering, or the like.

When forming the magnetic recording layers 112, an RF bias, a DC bias, a pulsed DC bias, or the like may be used, if necessary.

As a reactive gas, an O₂ gas, an H₂O gas, an N₂ gas, or the like may be used.

The sputtering gas pressure is appropriately adjusted to optimize the properties of resulting layers, but is typically within a range of about 0.1 (pascal) Pa to about 30 (pascal) Pa.

Next, the protective layers 113 are respectively formed over the magnetic recording layers 112. No particular limitation is imposed on a method for forming the protective layers 113, and it is possible to use a typical film-forming method. Examples of the method for forming the protective layers 113 include, for example: radio frequency-chemical vapor deposition (RF-CVD) in which a film is formed by decomposing a raw material gas of a hydrocarbon with a high-frequency plasma; ion beam deposition (IBD) in which a film is formed by ionizing a raw material gas with electrons emitted from a filament; and a filtered cathodic vacuum arc (FCVA) process in which a film is formed using a solid carbon target.

In the present embodiment, the stack formation step may form an adhesion layer, a soft magnetic base layer, a seed layer, an orientation control layer, or the like, between the substrate 111 and the magnetic recording layer 112.

In the present embodiment, when the stack 11 includes a plurality of the magnetic recording layers 112 that are stacked, the stack formation step may include, for example, forming a non-magnetic layer between the magnetic recording layers 112.

Next, a lubricant is applied to the surface of the stack 11 to form the lubricating layers 12 formed of the lubricant (lubricating layer formation step). This produces the magnetic recording medium 1, which is a multilayer product including the lubricant layers 12 respectively formed over the surfaces of the stack 11.

The application of the lubricant can be performed using a typical application method, such as dipping, spin coating, a vapor method, or the like.

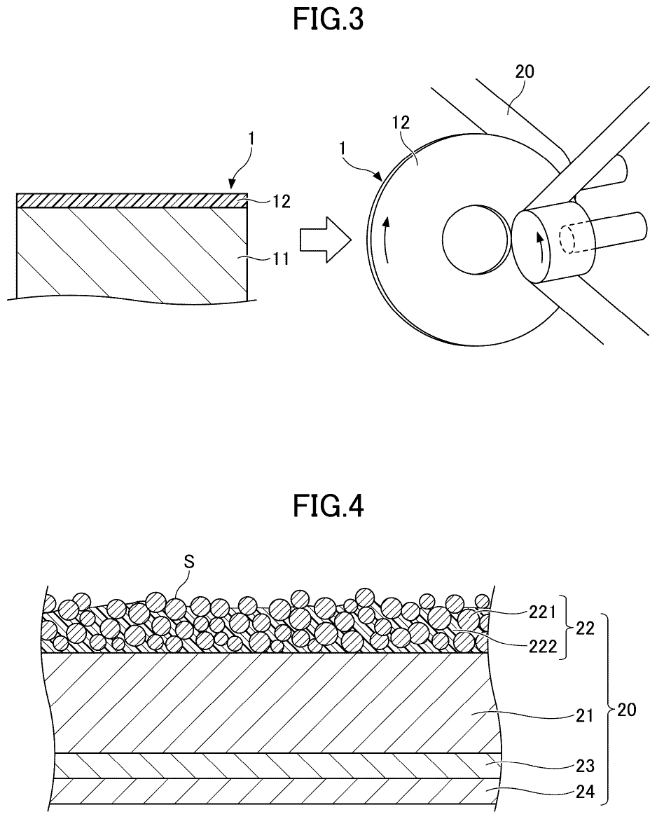

Next, as illustrated in FIG. 3, the surfaces of the lubricating layers 12 respectively formed over both surfaces of the stack 11 are burnished with an abrasive-containing tape (hereinafter may be referred to as an abrasive tape) 20 (burnishing step).

The burnishing step includes, by use of the abrasive tape 20 that is in a state of being wound in a roll shape, pressing the abrasive tape 20, supplied from the abrasive tape 20 in the state of being wound in the roll shape, against the surface of the stack 11 to abrade the surface of the stack 11.

The abrasive tape 20 is elongated. Thus, as illustrated in FIG. 1, the abrasive tape 20 is supplied in a state of being wound in a roll shape, and set, in use, to a reel of a burnishing apparatus in the state of being wound in the roll shape.

The burnishing can be performed by: using the abrasive tape 20 in the state of being wound in the roll shape; pressing the abrasive tape 20, supplied from the abrasive tape 20 in the state of being wound in the roll shape, against the surfaces of the lubricating layers 12 respectively formed over the surfaces of the stack 11; and abrading the surfaces of the lubricating layers 12. This can form the stack 11 in which both surfaces of the stack 11 are burnished.

FIG. 4 is an enlarged cross-sectional diagram illustrating an example of the abrasive tape 20 used in burnishing. As illustrated in FIG. 4, the abrasive tape 20 can abrade the surface of the lubricating layer 12 by sliding abrasion surfaces S relative to the surfaces of the lubricating layers 12 respectively formed over the surfaces of the stack 11.

The abrasive tape 20 includes a support 21, an abrasive layer 22 over one surface of the support 21, and an adhesive layer 24 over another surface of the support 21. According to the abrasive tape 20 having such a structure, the adhesive layer 24 can trap abrasive grains released due to the tight winding of the abrasive tape 20 in the roll shape. Therefore, it is possible to suppress circumferential scratches in the surfaces of the lubricating layers 12 in the burnishing step, and stains adhering to the surfaces of the lubricating layers 12, thereby increasing production efficiency of the magnetic recording medium 1. Also, the adhesive layer 24 is readily elastically deformed to mitigate the tight winding of the abrasive tape 20 in the roll shape. This can suppress the release of the abrasive grains, thereby increasing production efficiency of the magnetic recording medium 1.

The adhesive layer 24 preferably contains one or more adhesives selected from the group consisting of rubber-based adhesives, acrylic adhesives, urethane-based adhesives, and silicone-based adhesives. The adhesive layer 24 containing such an adhesive can readily trap the released abrasive grains, and suppress release of the abrasive grains by virtue of the resulting higher elastic deformability, thereby increasing production efficiency of the magnetic recording medium 1.

The thickness of the adhesive layer 24 is appropriately determined in accordance with the particle diameter of the abrasive grains to be trapped, but is preferably about several times or more the particle diameter of the abrasive grains to be trapped. The thickness of the adhesive layer 24 is preferably, for example, about 0.1 micrometers (μm) to about 50 micrometers (μm), and more preferably 0.5 μm to 20 μm.

The support 21 preferably contains one or more resins selected from the group consisting of polyester-based resins, polyolefin-based resins, acrylic resins, and polycarbonates. By forming the support 21 using such a resin or resins, the abrasive tape 20 can ensure mechanical properties, i.e., strength, heat resistance, and flexibility.

As the polyester-based resin, for example, it is preferable to use a resin containing, as a main component, polyethylene terephthalate, polybutylene terephthalate, polyethylene naphthalate, or the like. As the polyolefin-based resin, for example, it is preferable to use a resin containing, as a main component, polyethylene, polypropylene, or the like. As the acrylic resin, for example, it is preferable to use a resin containing, as a main component, polystyrene, polyvinyl chloride, polyvinyl alcohol, methacrylic alcohol, or the like.

The thickness of the support 21 is, for example, preferably within a range of 5 μm to 100 μm, and more preferably within a range of 10 μm to 75 μm, for ensuring mechanical properties of the abrasive tape 20.

The abrasive layer 22 can be formed of abrasive grains 221 and a binder 222 for fixing the abrasive grains 221 to the support 21.

Examples of the abrasive grains 221 include particles containing chromium oxide, α-alumina, silicon carbide, non-magnetic iron oxide, diamond, γ-alumina, α, γ-alumina, fused alumina, corundum, artificial diamond, or the like. The abrasive grains 221 may be grains formed of any one of these materials, or may be grains formed of two or more of these materials that are appropriately combined.

No particular limitation is imposed on the binder 222, and a thermosetting resin, a thermoplastic resin, a photosensitive resin, or the like can be used. The resins used as the binder 222 may be used alone or in combination.

The abrasive tape 20 preferably further includes an undercoat layer 23 between the support 21 and the adhesive layer 24. By providing the undercoat layer 23 between the support 21 and the adhesive layer 24, adhesion between the support 21 and the adhesive layer 24 is improved, and the adhesive of the adhesive layer 24 is prevented from being transferred to the abrasion surfaces S to stain the abrasion surfaces S.

The undercoat layer 23 preferably contains one or more adhesives selected from the group consisting of rubber-based resins, epoxy resins, polyurethane resins, acrylic resins, polyester resins, silicone resins, silane coupling agents, polyolefin-based resins, polycarbonate resins, and polyurethane resins.

No particular limitation is imposed on the thickness of the undercoat layer 23. The thickness of the undercoat layer 23 is typically within a range of 0.1 μm to 6 μm, and preferably within a range of 0.5 μm to 3 μm.

When selecting the materials forming the support 21, the undercoat layer 23, and the adhesive layer 24, it is preferable to consider mutual compatibility.

For example, when the adhesive layer 24 is formed using a rubber-based adhesive, the undercoat layer 23 may be formed using a rubber-based resin (e.g., chloroprene rubber, polyisoprene, or polybutadiene), an epoxy resin, a polyurethane resin, or the like. When the adhesive layer 24 is formed using an acrylic adhesive, the undercoat layer 23 may be formed using an acrylic resin, a polyester resin, an epoxy resin, a polyurethane resin, or the like. When the adhesive layer 24 is formed using a urethane-based adhesive, the undercoat layer 23 may be formed using a polyurethane resin, an epoxy resin, an acrylic resin, or the like. When the adhesive layer 24 is formed using a silicone-based adhesive, the undercoat layer 23 may be formed using a silicone resin, a silane coupling agent, an epoxy resin, or the like.

When the support 21 is formed using a polyester-based resin, the undercoat layer 23 may be formed using a polyester resin, an epoxy resin, an acrylic resin, or the like. When the support 21 is formed using a polyolefin resin, the undercoat layer 23 may be formed using a polyolefin-based resin, an epoxy resin, chloroprene rubber, or the like. When the support 21 is formed using an acrylic resin, the undercoat layer 23 may be formed using an acrylic resin, a polyester resin, an epoxy resin, or the like. When the support 21 is formed using a polycarbonate, the undercoat layer 23 may be formed using a polycarbonate resin, an epoxy resin, a polyurethane resin, or the like.

As described above, the abrasive tape 20 is elongated. Thus, as illustrated in FIG. 1, the abrasive tape 20 is supplied in a state of being wound in a roll shape, and set, in use, to a reel of a burnishing apparatus in the state of being wound in the roll shape.

When the abrasive tape 20 is formed in a roll shape, the pressure due to the tight winding generates released abrasive grains in a roll. Here, when the pressure due to the tight winding is very high, the abrasive grains 221 strongly bonded to the support 21 can be released, but it is considered that the abrasive grains 221 weakly bonded to the support 21 and the abrasive grains 221 attached to the bonded abrasive grains 221 are typically released. In this manner, it is difficult to completely remove the released abrasive grains 221 during the production process of the abrasive tape 20. Many of the released abrasive grains are considered to form after the production of the abrasive tape 20, i.e., after the abrasive tape 20 is wound in a roll shape.

The abrasive tape 20 can reduce release of the abrasive grains, and trap released abrasive grains at the rear surface of the abrasive tape 20. Thus, even if the abrasive grains are released, it is possible to suppress an adverse effect of the released abrasive grains on the magnetic recording medium 1 in the burnishing step.

In the burnishing step, it is possible to use a method in which the abrasive tape 20 is pressed, for the purpose of abrasion, against the surfaces of the lubricating layers 12 respectively formed over the surfaces of the stack 11. An example of the burnishing apparatus will be described in detail with reference to the drawings.

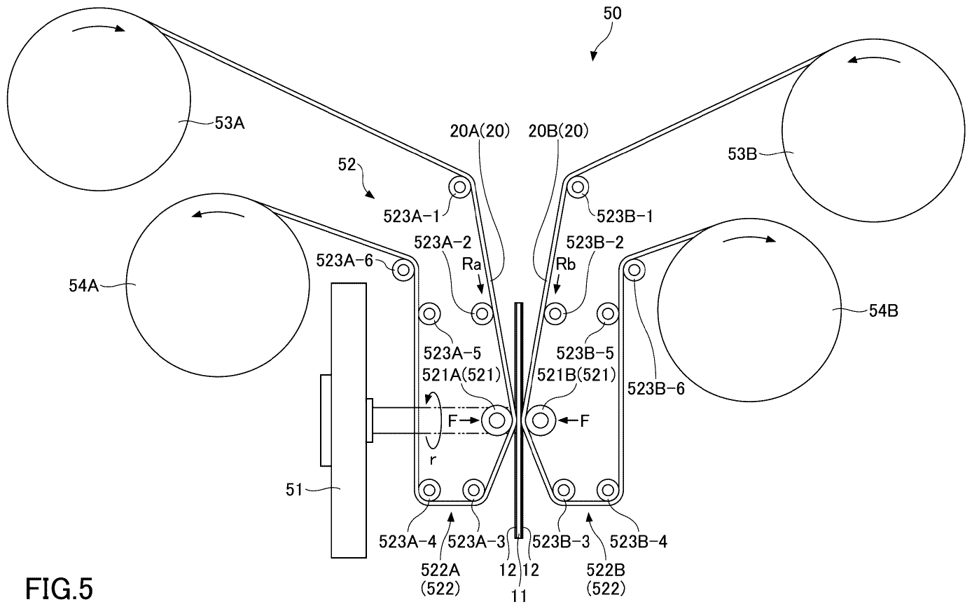

FIG. 5 is a diagram illustrating an example of the burnishing apparatus used in burnishing the stack 11 with the abrasive tape 20. As illustrated in FIG. 5, a burnishing apparatus 50 includes: a set of the abrasive tapes 20 (hereinafter may be referred to as a “set of abrasive tapes 20A and 20B”) that are disposed to face each other so as to sandwich the stack 11 from both surfaces of the stack 11 including the lubricating layers 12 respectively formed over the surfaces; a rotation support 51; and a tape moving unit 52.

The set of abrasive tapes 20A and 20B are respectively supplied from a first abrasive tape supply reel 53A and a second abrasive tape supply reel 53B in a state of being wound in a roll shape, and are respectively wound up by a first abrasive tape winding-up reel 54A and a second abrasive tape winding-up reel 54B in a state of being wound in a roll shape.

In the burnishing apparatus 50, the set of abrasive tapes 20A and 20B are disposed to face each other so as to sandwich the stack 11 from both surfaces of the stack 11 including the lubricating layers 12 respectively formed over the surfaces. With this configuration, the burnishing apparatus 50 can burnish the stack 11 simultaneously and efficiently.

The rotation support 51 is configured to rotate the stack 11, including the lubricating layers 12 respectively formed over the surfaces, in a circumferential direction (direction indicated by an arrow r in FIG. 5) while supporting a center opening of the stack 11 including the lubricating layers 12 respectively formed over the surfaces.

The tape moving unit 52 is configured to move the set of abrasive tapes 20A and 20B in a radial direction of the stack 11 relative to the stack 11 while pressing the set of abrasive tapes 20A and 20B, in directions indicated by arrows F, against the lubricating layers 12 respectively formed over both surfaces of the rotating stack 11.

The tape moving unit 52 includes: a pair of abrasive tape pressing members 521, which are disposed to face each other so as to sandwich the stack 11, including the lubricating layers 12 respectively formed over the surfaces, from both surfaces of the stack 11 through the set of abrasive tapes 20A and 20B; and a pair of abrasive tape drive systems 522, which are disposed to face each other so as to sandwich the stack 11, including the lubricating layers 12 respectively formed over the surfaces, from both surfaces of the stack 11 through the set of abrasive tapes 20A and 20B.

The pair of abrasive tape pressing members 521 include a first abrasive tape pressing member 521A and a second abrasive tape pressing member 521B. The pair of abrasive tape drive systems 522 include a first abrasive tape drive system 522A and a second abrasive tape drive system 522B.

That is, the tape moving unit 52 includes: the first abrasive tape pressing member 521A and the first abrasive tape drive system 522A, which are disposed on one side across the stack 11 including the lubricating layers 12 respectively formed over the surfaces; and the second abrasive tape pressing member 521B and the second abrasive tape drive system 522B, which are disposed on the other side.

The first abrasive tape pressing member 521A is a pressing member configured to press the abrasive tape 20A, supplied from the first abrasive tape supply reel 53A, toward the stack 11 (in a direction indicated by an arrow F on the left side in FIG. 5).

The second abrasive tape pressing member 521B is a pressing member configured to press the abrasive tape 20B, supplied from the second abrasive tape supply reel 53B, toward the stack 11 (in a direction indicated by an arrow F on the right side in FIG. 5).

The first abrasive tape drive system 522A includes first guide rollers 523A-1 to 523A-6, and is configured to drive the abrasive tape 20A in a direction indicated by an arrow Ra.

The second abrasive tape drive system 522B includes second guide rollers 523B-1 to 523B-6, and is configured to drive the abrasive tape 20B in a direction indicated by an arrow Rb.

As described above, the magnetic recording medium 1 produced by the magnetic recording medium production method according to the present embodiment has a small amount of circumferential scratches, stains, and the like in the surface of the magnetic recording medium 1, and can have an increased reliability of quality. The magnetic recording medium 1 can suppress defects of reading-in and reading-out with respect to recording, and maintain a high recording density. Thus, the magnetic recording medium 1 is suitably used for a magnetic recording and reproducing device. No particular limitation is imposed on a form of the magnetic recording and reproducing device as long as the magnetic recording and reproducing device includes a magnetic recording medium produced by the magnetic recording medium production method according to the present embodiment. The magnetic recording and reproducing device may be, for example, a magnetic recording and reproducing device configured to record magnetic information in the magnetic recording medium by a heat-assisted recording method.

Although the embodiments have been described above, the above embodiments are presented just as examples, and the present disclosure is not limited to the above embodiments. The above embodiments can be implemented in various other forms, and various combinations, omissions, substitutions, modifications, and the like are possible without departing from the intent of the present invention. The above embodiments and modifications thereof are included in the scope and intent of the present invention, and are also included in the scope of the inventions recited in claims and in the scope of equivalents thereof.

### EXAMPLES

Hereinafter, the present embodiment will be described in more detail by way of examples, but the present embodiment is not limited to the examples.

### Production of Abrasive Tape

### Example 1

A polyethylene terephthalate tape having a thickness of 24 μm in which Al₂O₃ grains (i.e., abrasive grains serving as an abrasive) having a particle diameter of 0.2 μm were bonded to one surface of the tape with a thermosetting resin was provided. This tape had a width of 12.6 millimeters (mm) and a length of 100 m. An acrylic resin was applied as an undercoat layer to the rear surface of this tape such that the thickness of the resulting undercoat layer after drying would be 1 μm. Subsequently, an adhesive layer was formed over the undercoat layer by applying a solvent solution of an adhesive composition containing, as a main component, an elastomer containing 80% natural rubber and 20% liquid isoprene rubber such that the thickness of the resulting adhesive layer would be 3 μm, followed by drying, thereby producing an abrasive tape.

### Comparative Example 1

An abrasive tape of Comparative Example 1 was produced in the same manner as in Example 1 except that, unlike in Example 1, the undercoat layer and the adhesive layer were not formed over the rear surface of the tape.

### Confirmation of Trapping of Removed Abrasive Grains

Each of the produced abrasive tapes of Example 1 and Comparative Example 1 was wound around a core material in a roll shape at a tension of 10 newtons (N). The obtained abrasive tape in the roll shape was left for one week. After one week, the abrasive tape in the roll shape was unwound, and the rear surface of the abrasive tape was observed with a scanning electron microscope (SEM).

The abrasive tape of Example 1 was confirmed to trap removed abrasive grains with the adhesive layer. Also, the amount of the removed abrasive grains trapped by the adhesive layer was confirmed to be smaller in the abrasive tape of Example 1 than in the abrasive tape of Comparative Example 1. This is likely because the abrasive tape of Example 1 experienced a reduction in the pressure caused by the tight winding, and thus the number of the removed abrasive grains was reduced.

Therefore, compared to the abrasive tape of Comparative Example 1, the abrasive tape of Example 1 can reduce the amount of the removed abrasive grains, and can suppress circumferential scratches, stains, and the like in the surface of the magnetic recording medium 1, thereby increasing production efficiency of the magnetic recording medium.

According to one aspect of the present disclosure, it is possible to increase production efficiency of a magnetic recording medium.

What is claimed is:

1. An abrasive tape that is an elongated tape wound in a roll shape, the abrasive tape comprising:
a support,
abrasive grains fixed, as an abrasive, to one surface of the support, and
an adhesive layer over another surface of the support.

2. The abrasive tape according to claim 1, wherein
the adhesive layer contains one or more adhesives selected from the group consisting of rubber-based adhesives, acrylic adhesives, urethane-based adhesives, and silicone-based adhesives.

3. The abrasive tape according to claim 1, wherein
the support contains one or more resins selected from the group consisting of polyester-based resins, polyolefin-based resins, acrylic resins, and polycarbonates.

4. The abrasive tape according to claim 1, further comprising:
an undercoat layer between the support and the adhesive layer.

5. The abrasive tape according to claim 4, wherein
the undercoat layer contains one or more adhesives selected from the group consisting of rubber-based resins, epoxy resins, polyurethane resins, acrylic resins, polyester resins, silicone resins, silane coupling agents, polyolefin-based resins, polycarbonate resins, and polyurethane resins.

6. A magnetic recording medium production method, comprising:
burnishing, with an abrasive, a surface of a stack including a substrate, a magnetic recording layer over the substrate, and a protective layer over the magnetic recording layer, wherein
the burnishing includes
by use of an abrasive tape that is elongated and is in a state of being wound in a roll shape, pressing the abrasive tape, supplied from the abrasive tape in the state of being wound in the roll shape, against the surface of the stack to abrade the surface of the stack, and
the abrasive tape includes
a support,
abrasive grains fixed, as the abrasive, to one surface of the support, and
an adhesive layer over another surface of the support.

7. The magnetic recording medium production method according to claim 6, further comprising:
forming a lubricating layer over the surface of the stack, wherein
the burnishing burnishes, with the abrasive, a surface of the stack over which the lubricating layer is formed.
